(19) United States
(12) Patent Application Publication
(10) Pub. No.: US 2009/0102332 A1
(43) Pub. Date: Apr. 23, 2009

(54) Cabinet door locking mechanism

(76) Inventor: Jerel Richard Lear, Holyoke, MA (US)

Correspondence Address: CANTOR COLBURN, LLP, 20 Church Street, 22nd Floor, Hartford, CT, 06103, US

(21) Appl. No.: 11/975,218

(22) Filed: Oct. 18, 2007

(51) Int. Cl. E05B 53/00; E05B 3/00; E05B 65/44

(52) U.S. Cl. 312/218; 292/336.3; 70/82

(57) ABSTRACT

A locking mechanism for a cabinet door is disclosed. A handle pivotally attached to the cabinet door has a first portion on a front side of the door and a second portion on a back side of the door, wherein rotation of the first portion causes rotation of the second portion. An upper rod is pivotally coupled to the second portion of the handle and is translationally coupled to an upper guide via two regions of engagement. A lower rod is pivotally coupled to the second portion of the handle and is translationally coupled to a lower guide via two regions of engagement. Rotation of the handle causes translational movement of the upper rod relative to the upper guide in a line of motion defined by the two regions of engagement at the upper guide, and causes translational movement of the lower rod relative to the lower guide in a line of motion defined by the two regions of engagement at the lower guide.

### BACKGROUND OF THE INVENTION

The present disclosure relates generally to a cabinet door locking mechanism, and particularly to a guide for a cabinet door locking mechanism.

Metal storage cabinets include door arrangements that can be locked in the closed position using any one of a one-point, two-point or three-point locking arrangement. The one-point locking arrangement can be achieved by the door handle having a latch that engages with a stationary portion of the cabinet upon rotation of the handle with the door closed. The two-point locking arrangement can be achieved by locking rods driven by rotation of the door handle to engage the cabinet door frame at the top and bottom of the cabinet with the door closed. The three-point locking arrangement can be achieved by combining the one-point and two-point locking arrangements. The locking rods that are driven by rotation of the door handle not only go through a translational movement at their free end distant from the handle, but the end of the rods attached to the handle also travel through an arc defined by the rotation of the handle and the point of attachment relative to the handle pivot. The greater the distance from the handle pivot that a locking rod is attached, the greater the translational movement of the rod for locking, however, as this distance increases so does the amount of angular displacement of the locking rod, which could cause binding of the locking rod if it is overly constrained. As such, the two-point or three-point locking arrangements that use the aforementioned locking rods typically employ only a single guide region at their free end distant from the handle, which is suitable for its intended purpose. However, improved door locking with tightly closed, rattle free doors may be more desirable in certain situations. Accordingly, improvements as disclosed herein would advance the art of cabinet door locking mechanisms.

### BRIEF DESCRIPTION OF THE INVENTION

An embodiment of the invention includes a locking mechanism for a cabinet door. The locking mechanism includes a handle, an upper rod guide, and a lower rod guide. The handle is pivotally attached to the cabinet door, and has a first portion on a front side of the door and a second portion on a back side of the door. The first portion is rigidly connected with the second portion such that rotation of the first portion causes rotation of the second portion. The upper guide and the lower guide are each fixedly attached to the back side of the door such that the upper and lower guides and the handle pivot are disposed substantially inline with each other proximate an edge of the door opposite a hinged edge of the door. An upper rod is pivotally coupled to the second portion of the handle and is translationally coupled to the upper guide via two regions of engagement. A lower rod is pivotally coupled to the second portion of the handle and is translationally coupled to the lower guide via two regions of engagement. Rotation of the handle causes translational movement of the upper rod relative to the upper guide in a line of motion defined by the two regions of engagement at the upper guide, and causes translational movement of the lower rod relative to the lower guide in a line of motion defined by the two regions of engagement at the lower guide.

Another embodiment of the invention includes a cabinet having a body, a door and a locking mechanism. The door is hinged to the body and is capable of being opened and closed, the body and door defining an interior space of the cabinet. The locking mechanism includes a handle, upper and lower guides, and upper and lower rods. The handle is pivotally attached to the door and has a first portion on a front side of the door and a second portion on a back side of the door, the first portion being rigidly connected with the second portion such that rotation of the first portion causes rotation of the second portion. The upper guide and lower guide are each fixedly attached to the back side of the door such that the upper and lower guides and the handle pivot, are disposed substantially inline with each other proximate an edge of the door opposite the hinged edge of the door. The upper rod is pivotally coupled to the second portion of the handle and is translationally coupled to the upper guide via two regions of engagement. The lower rod is pivotally coupled to the second portion of the handle and is translationally coupled to the lower guide via two regions of engagement. Rotation of the handle causes translational movement of the upper rod relative to the upper guide in a line of motion defined by the two regions of engagement at the upper guide, and causes translational movement of the lower rod relative to the lower guide in a line of motion defined by the two regions of engagement at the lower guide.

A further embodiment of the invention includes a cabinet having a body, a door, and a locking mechanism. The door is hinged to the body and is capable of being opened and closed, the body and door defining an interior space of the cabinet. The locking mechanism is coupled to the door and includes a handle, upper and lower rods, and means for guiding the upper and lower rods. The handle is pivotally attached to the door and has a first portion on a front side of the door and a second portion on a back side of the door, the first portion being rigidly connected with the second portion such that rotation of the first portion causes rotation of the second portion. The upper rod is pivotally coupled to the second portion of the handle and is translationally extendable and retractable via rotation of the handle to effect locking and unlocking of the door with respect to an upper lip of the body. The lower rod is pivotally coupled to the second portion of the handle and is translationally extendable and retractable via rotation of the handle to effect locking and unlocking of the door with respect to a lower lip of the body. The means for guiding the upper rod and the means for guiding the lower rod provide for the upper rod and the lower rod to translate in unison substantially inline with an edge of the door opposite the hinged edge of the door in response to rotation of the handle. The means for guiding the upper rod and the means for guiding the lower rod each have more than one means for restraining the respective upper and lower rods to oppose an opening action of the door in response to the door being closed, the locking mechanism being in a locked position, and the door experiencing a force attempting to open the door.

These and other advantages and features will be more readily understood from the following detailed description of preferred embodiments of the invention that is provided in connection with the accompanying drawings.

### BRIEF DESCRIPTION OF THE DRAWINGS

Referring now to the drawings, which are meant to be exemplary and not limiting, and wherein like elements are numbered alike in the accompanying Figures:

FIG. 1 depicts a front isometric view of an exemplary cabinet for use in accordance with an embodiment of the invention;

FIG. 2 depicts the cabinet of FIG. 1 with doors open illustrating an exemplary locking mechanism in an unlocked position in accordance with an embodiment of the invention;

FIG. 3 depicts the cabinet of FIG. 1 with doors open illustrating the exemplary locking mechanism of FIG. 2 in a locked position in accordance with an embodiment of the invention;

FIG. 4 depicts a rear isometric cutaway view of the cabinet of FIG. 2 with doors closed;

FIG. 5 depicts a rear isometric cutaway view of the cabinet of FIG. 3 with doors closed;

FIG. 6 depicts a portion of the exemplary locking mechanism of FIG. 2 in two positions in accordance with an embodiment of the invention; and

FIGS. 7-10 depict in isometric view alternative exemplary guides in accordance with embodiments of the invention.

### DETAILED DESCRIPTION OF THE INVENTION

An embodiment of, the invention, as shown and described by the various figures and accompanying text, provides a cabinet door locking mechanism with an improved locking rod guide having two regions of engagement on each of an upper and a lower locking rod, thereby improving tight closure of the cabinet door and eliminating or substantially reducing door rattle when closed. While the embodiment described herein depicts a metal box cabinet for use with the novel door locking mechanism, it will be appreciated that the disclosed embodiment is also applicable to other enclosures, such as cabinets of any size or shape, cabinets made from a material other than metal, such as plastic, and enclosures not necessarily classified as cabinets, such as storage bins, for example.

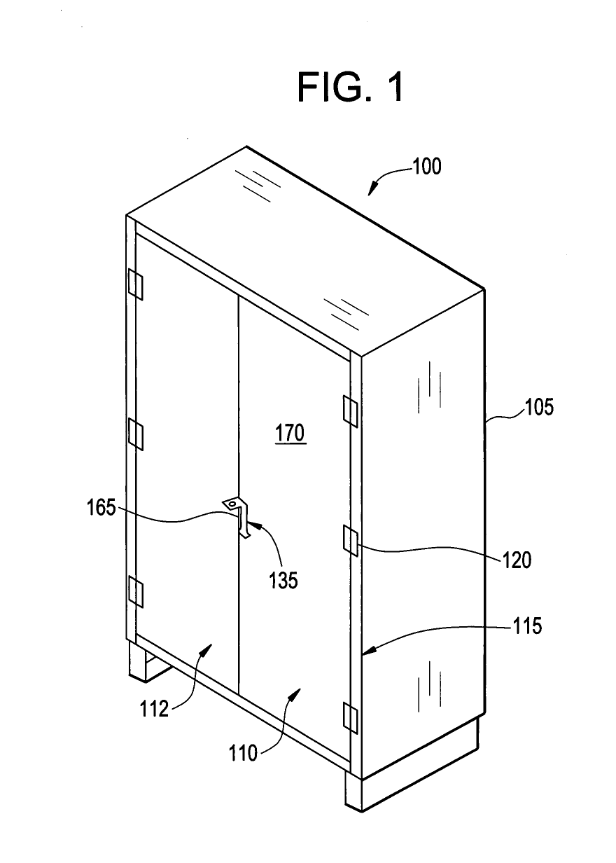

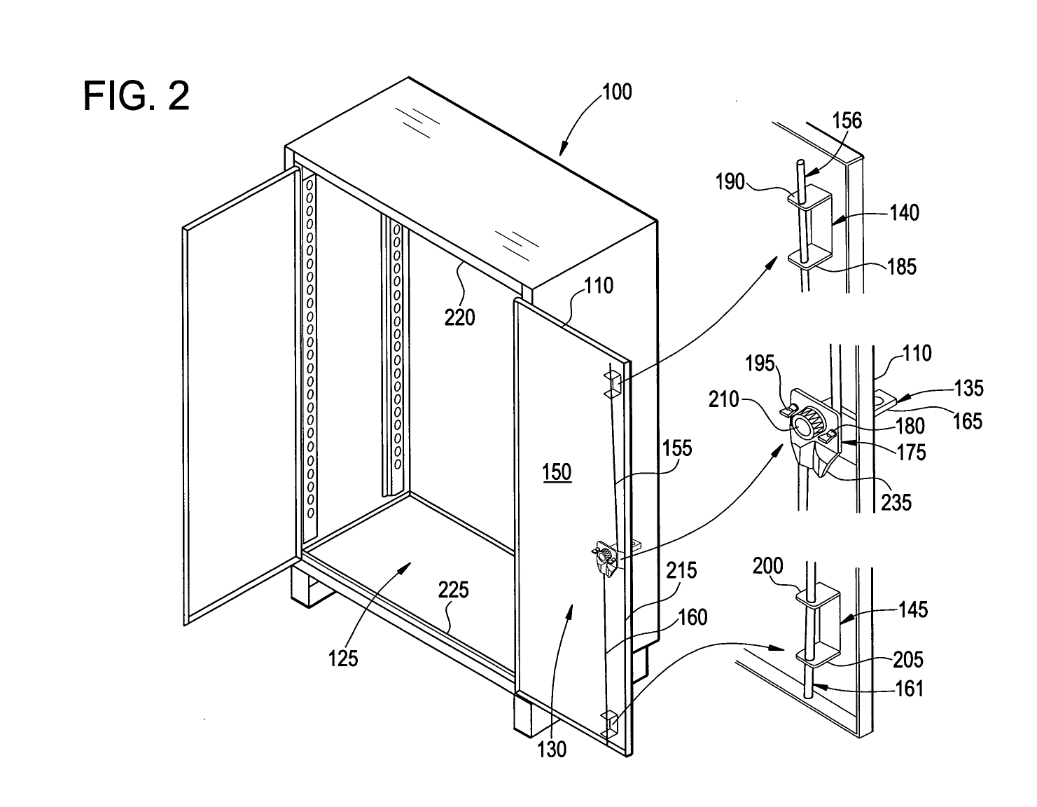

FIG. 1 is an exemplary embodiment of a cabinet 100 having a body 105 and a door 110 hinged to the body 105 at an edge 115, the door 110 being capable of opening and closing via hinges 120. Cabinet 100 may have only one door 110 in a single-door cabinet arrangement, or may have two doors 110, 112 in a two-door cabinet arrangement. An interior space 125 of the cabinet 100 is defined by the body 105 and door 110, which is best seen by referring to FIG. 2.

Referring now to FIG. 2, a locking mechanism 130, used for securely locking the door 110 in the closed position, includes a handle 135 (best seen by referring to FIG. 1) pivotally attached to the door 110, an upper guide 140 and a lower guide 145 each fixedly attached to a back side 150 of the door 110, and an upper locking rod 155 and a lower locking rod 160. The handle 135 has a first portion 165 on a front side 170 of the door 110 (best seen by referring to FIG. 1) and a second portion 175 on the back side 150 of the door 110, the first portion 165 being rigidly connected with the second portion 175 such that rotation of the first portion 165 causes rotation of the second portion 175. The upper rod 155 is pivotally coupled to the second portion 175 of the handle 135 at coupling 180. From a manufacturing perspective, coupling 180 can be formed by bending the upper rod 155 to form a pivot leg, passing the bent pivot leg through a hole in the second portion 175, and then swedging the bent pivot leg in place. The upper rod 155 is also translationally coupled to the upper guide 140 via two regions of engagement 185, 190, which in an embodiment are equally sized circular holes in the leg portions (generally referred to by reference numerals 185, 190) of a C-shaped upper guide 140 through which the upper rod 155 passes. The lower rod 160 is connected to the handle 135 and the lower guide 145 in a similar manner (see coupling 195 and engagement regions 200, 205 in FIG. 2). The upper and lower guides 140, 145 and the handle pivot 210 are disposed substantially inline with each other proximate an edge 215 of the door 110 that is opposite the hinged edge 115 of the door 110. Coupling 180 and coupling 195 are disposed on opposite sides of handle pivot 210, thereby enabling opposing translational movement of upper and lower rods 155, 160 as handle 135 is turned in a given direction. In an embodiment, the upper and lower guides 140, 145 are identically configured with respect to each other, thereby reducing assembly errors during the manufacturing process of the locking mechanism 130 and the cabinet 100.

As will be appreciated from the aforementioned description of structure, rotation of the handle 135 will cause translational movement of the upper rod 155 relative to the upper guide 140 in a line of motion defined by the two regions of engagement 185, 190 at the upper guide 140, and will likewise cause translational movement of the lower rod 160 relative to the lower guide 145 in a line of motion defined by the two regions of engagement 200, 205 at the lower guide 145.

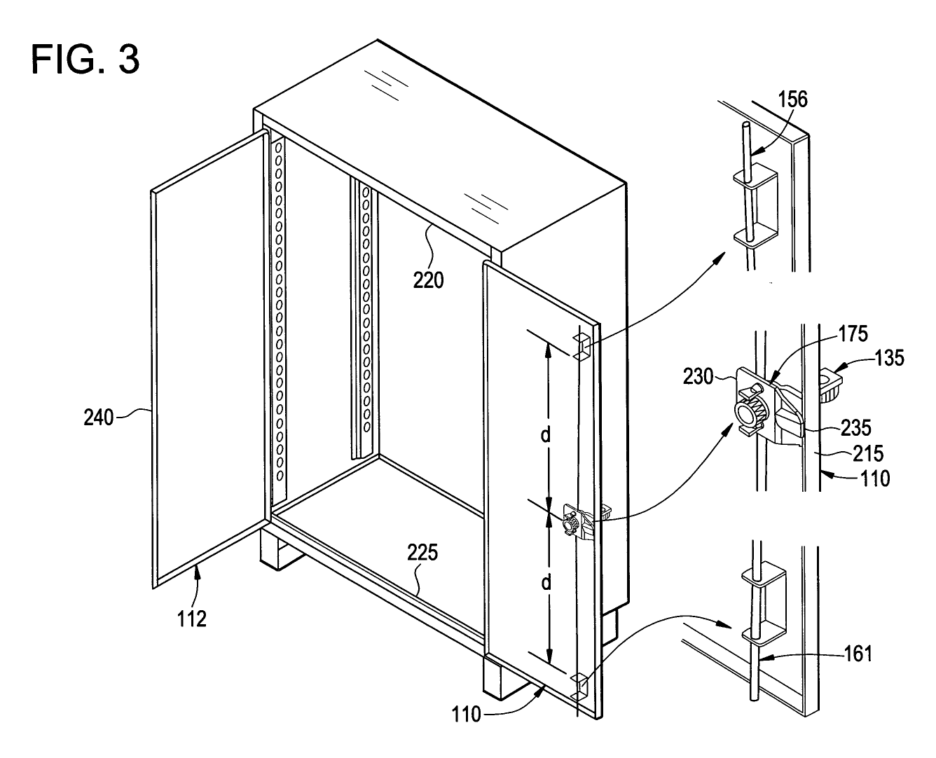

The handle 135 is positionable in a first position (illustrated in FIG. 2) and a second position (best seen by referring to FIG. 3), where the first position of the handle 135 depicts the locking mechanism 130 in an unlocked position, and the second position of the handle 135 depicts the locking mechanism 130 in a locked position.

The first position, with reference to FIG. 2, results in the upper rod 155 having its upper end 156 partially restrained (that is, translational movement permitted) by the two regions of engagement 185, 190 in the upper guide 140 and being positioned in a retracted position, and the lower rod 160 having its lower end 161 partially restrained by the two regions of engagement 200, 205 in the lower guide 145 and being positioned in a retracted position.

The second position, with reference to FIG. 3, results in the upper rod 155 having its upper end 156 partially restrained by the two regions of engagement 185, 190 in the upper guide 140 and being positioned in an extended position, and the lower rod 160 having its lower end 161 partially restrained by the two regions of engagement 200, 205 in the lower guide 145 and being positioned in an extended position.

With the handle 135 in the first position and the upper and lower rods 155, 160 in the retracted position, the upper and lower ends 156, 161 of upper and lower rods 155, 160, respectively, are positioned so as to clear upper and lower lips 220, 225, respectively, of cabinet body 105, thereby allowing the door 110 to be opened and closed.

With the handle 135 in the second position and the upper and lower rods 155, 160 in the extended position, the upper and lower ends 156, 161 of upper and lower rods 155, 160, respectively, are positioned so as to be captivated behind the upper and lower lips 220, 225, respectively, of cabinet body 105, thereby allowing the door 110 to be closed and locked with a two-point locking arrangement, the two-point locking arrangement being defined by the captivated upper and lower ends 156, 161 of upper and lower rods 155, 160 behind upper and lower lips 220, 225.

With reference now to FIG. 3, the second portion 175 of the handle 135 is seen to include a mounting portion 230 and a latch portion 235, where the upper and lower rods 155, 160 are each pivotally coupled to the mounting portion 230 at couplings 180, 195, as discussed above.

With the handle 135 in the first position (see FIG. 2 in concert with FIG. 3), the latch portion 235 is shadowed by the door 110 when viewed from the front side 170 of the door 110 (see FIG. 1 for illustration of the front side), thereby allowing the door 110 to open and close without the latch portion 235 coming in contact with an obstruction, such as a side edge of the cabinet body 105 for single door cabinets (not specifically shown, but considered to be understandable by a reading of the detailed description herein), or such as an outer edge 240 of an opposing door 112 for two-door cabinets (illustrated herein).

With the handle 135 in the second position (depicted in FIG. 3), the latch portion 235 extends beyond an outer edge 215 of the door 110 when viewed from the front side of the door, thereby permitting the latch portion 235 to be captivated behind the outer edge 240 of the opposing door 112 when closed, and allowing the door 110 to be closed and locked with a three-point locking arrangement. Here, two points of the three-point locking arrangement are as described above for the two-point locking arrangement, and the third point of the three-point locking arrangement is defined by the captivated latch portion 235 behind the outer edge 240 of the opposing door 112 when both doors 110, 112 are closed.

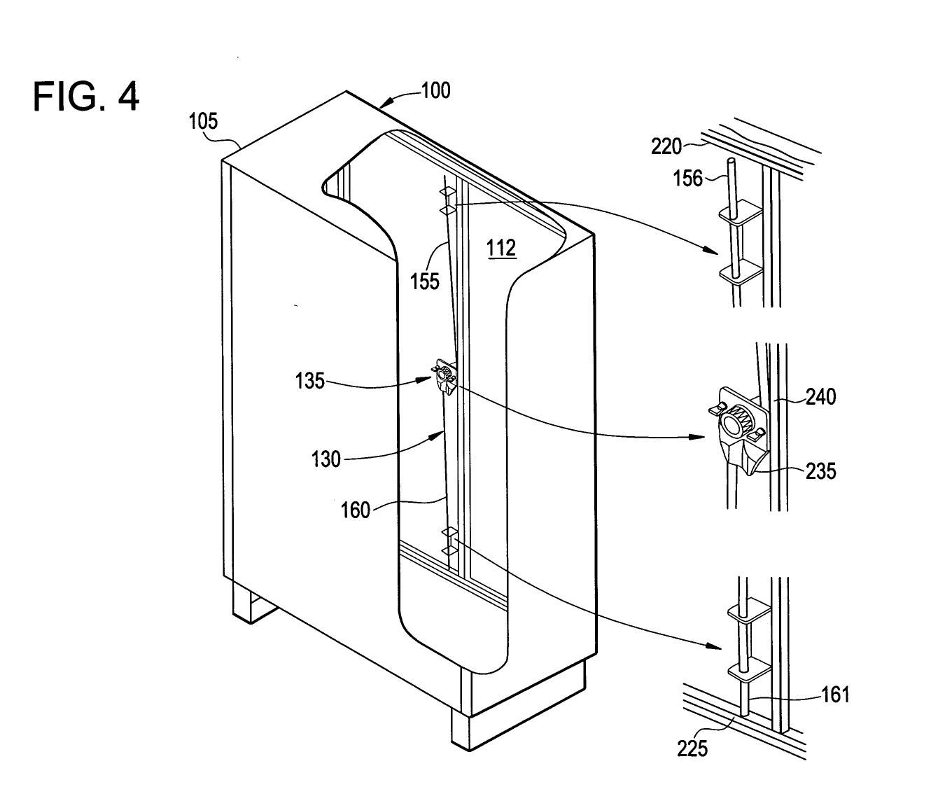

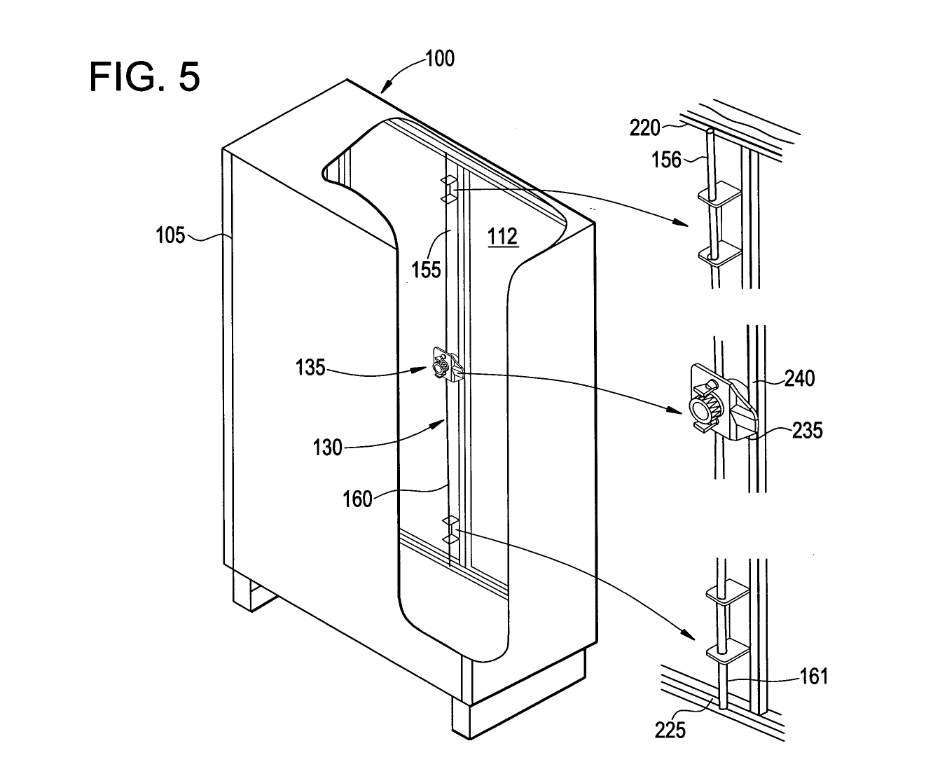

FIGS. 4 and 5 illustrate cutaway views of the cabinet 100 from the back side of the cabinet, with FIG. 4 depicting the locking mechanism 130 in an unlocked condition (upper end 156 of upper rod 155 clear of upper lip 220 of body 105, lower end 161 of lower rod 160 clear of lower lip 225 of body 105, and latch portion 235 of handle 135 clear of edge 240 of opposing door 112), and FIG. 5 depicting the locking mechanism 130 in a locked condition (upper end 156 of upper rod 155 captivated behind of upper lip 220 of body 105, lower end 161 of lower rod 160 captivated behind lower lip 225 of body 105, and latch portion 235 of handle 135 captivated behind edge 240 of opposing door 112).

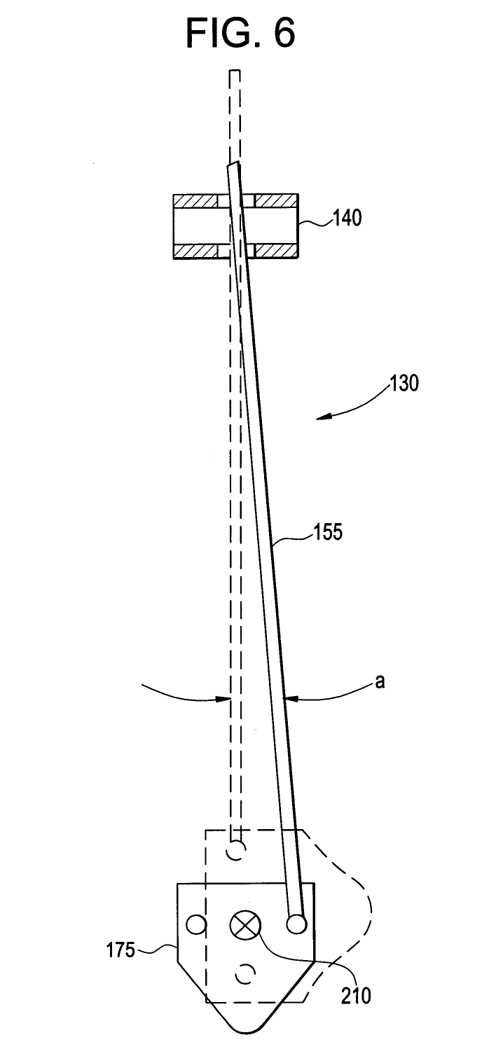

As discussed above, couplings 180, 195 of upper and lower rods 155, 160 are disposed on opposite sides of handle pivot 210, and upper and lower ends 156, 161 of upper and lower rods 155, 160 are restrained by upper and lower guides 140, 145 such that substantially only translational motion of the upper and lower ends 156, 161 is permitted, which results in the upper and lower rods 155, 160 swinging through an arc as the handle 135 is rotated. The degree of angular displacement “a” of upper and lower rods 155, 160 can be seen by comparing FIGS. 4 and 5 with each other, and by reference to FIG. 6. With reference briefly to FIG. 6, FIG. 6 depicts only second portion 175 of handle 135, upper rod 155, and upper guide 140, with the upper guide 140 depicted in section view to show the upper rod essentially pivoting about the upper hole of the upper guide as the handle 135 (and second portion 175) rotate about handle pivot 210. The solid lines of FIG. 6 illustrate the handle 135 in the first position (unlocked condition), and the dashed lines of FIG. 6 illustrate the handle 135 in the second position (locked condition). From the foregoing it will be appreciated that if the circular holes in the leg portions (generally referred to by reference numerals 185, 190) of C-shaped upper guide 140 through which the upper rod 155 passes, and the circular holes in the leg portions (generally referred to by reference numerals 200, 205) of C-shaped lower guide 145 through which the lower rod 160 passes, are too tight, then binding of the upper and lower rods 155, 160 will result at the holes closest to the door handle 135. To remedy a potential binding condition, several embodiments will now be described with reference to the upper guide 140. However, it Will be appreciated that the lower guide 145 is simply the mirror image of the upper guide 140 when the two guides are not identically configured with respect to each other.

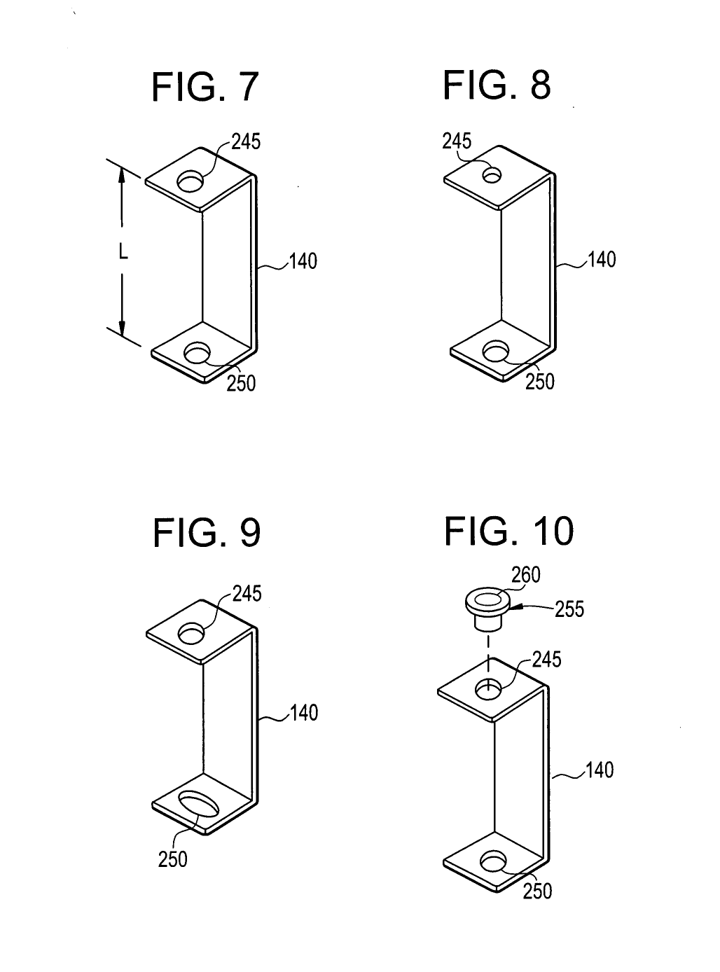

In a first embodiment, and with reference to FIG. 7, the upper hole 245 and lower hole 250 of upper guide 140 are equally sized with a diameter sufficient to accommodate the maximum swing of upper rod 155 at the lower hole 250.

In a second embodiment, and with reference to FIG. 8, the upper hole 245 of the upper guide 140 has a diameter smaller than the diameter of the lower hole 250. Here, the diameter of the lower hole 250 is sized to accommodate the maximum swing of the upper rod 155, and the upper hole 245 is sized primarily for clearance and translational movement of the upper rod 155.

In a third embodiment, and with reference to FIG. 9, the upper hole 245 of the upper guide 140 is circular in shape, and the lower hole 250 is oblong in shape with a major axis of the oblong shape being oriented to accommodate the motion of swing of the upper rod 155. Here, the clearance dimension along the major axis of the oblong shape is sized to accommodate the maximum swing of the upper rod 155, while the diameter of the upper hole 245 and the clearance dimension along the minor axis of the oblong shape are sized primarily for clearance and translational movement of the upper rod 155.

In a fourth embodiment, and with reference to FIG. 10, the upper and lower holes 245, 250 of upper guide 140 are sized the same as that for the first embodiment, and an insert 255 having a through hole 260 is securely placed in the upper hole 245. In an embodiment, the insert 255 has a snap fit engagement with the upper guide 140. Here, the diameter of the lower hole 250 is sufficiently sized to accommodate the maximum swing of upper rod 155, and the through hole 260 of the insert 255 is sized primarily for clearance and translational movement of the upper rod 155. Viewed another way, when the upper rod is passed through the lower hole 250 of the upper guide 140 and the through hole 260 of the insert 255, the upper rod 155 has more clearance to an inner edge of the lower hole 250 than to an inner edge of the insert through hole 260.

In an embodiment, the insert is made using a plastic material, which can be made naturally slippery with reduced sharp edges, thereby further reducing binding while improving the tightness of the locking action of the locking mechanism 130 and door 110.

The length “L” (see FIG. 7) of the upper and lower guides 140, 145 is preferably between 4 and 8 inches, with an embodiment having length “L” between 5 and 7 inches, and another embodiment having length “L” equal to 6 inches. Taking into consideration the length “L” of upper and lower guides 140, 145, and to further reduce binding of the upper and lower rods 155, 160 with respect to the upper and lower guides 140, 145 (more particularly with respect to the lower hole of the upper guide 140, and the upper hole of the lower guide 145), the upper and lower guides 140, 145 should be placed no closer than a minimum distance “d” (see FIG. 3) with respect to the pivot 210 of the handle 135. The minimum distance “d” is preferably equal to or less than 24 inches, with an embodiment having minimum distance “d” equal to or less than 20 inches, and another embodiment having minimum distance “d” equal to or less than 18 inches.

By employing the aforementioned locking mechanism 130 having upper and lower guides 140, 145, each with two engagement regions 185, 190 and 200, 205, respectively, a tighter locking action and reduced rattling of the doors 110, 112 results. Viewed alternatively, the engagement regions 185, 190 and 200, 205 provide a means for guiding the upper rod 155 and a means for guiding the lower rod 160 where each means for guiding 140, 145 have more than one means for restraining (regions 185, 190 for guide 140, and regions 200, 205 for guide 145) the respective upper and lower rods 155, 160 to oppose an opening action of the door 110 in response to the door being closed, the locking mechanism 130 being in a locked position, and the door experiencing a force attempting to open the door. While loosely fitting locked doors that are allowed to rattle when locked may not pose a problem in many situations, it nonetheless may be a quality concern of a potential customer. As such, the aforementioned locking mechanism 130 offers the advantage of improved quality over other cabinet designs not employing the aforementioned locking mechanism 130.

While certain combinations of holes 245, 250 in upper and lower guides 140, 145 have been described herein, it will be appreciated that these certain combinations are for illustration purposes only and that any combination of any of the aforementioned holes and guides may be employed in accordance with an embodiment of the invention. Any and all such combinations are contemplated herein and are considered within the scope of the invention disclosed.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to any particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc., do not denote any order or importance, but rather the terms first, second, etc. are used to distinguish one element from another. Furthermore, the use of the terms a, an, etc., do not denote a limitation of quantity, but rather denote the presence of at least one of the referenced item.

1. A locking mechanism for a cabinet door, the locking mechanism comprising:
a handle pivotally attached to the cabinet door, the handle having a first portion on a front side of the door and a second portion on a back side of the door, the first portion being rigidly connected with the second portion such that rotation of the first portion causes rotation of the second portion;
an upper guide and a lower guide each fixedly attached to the back side of the door such that the upper and lower guides and the handle pivot are disposed substantially inline with each other proximate an edge of the door opposite a hinged edge of the door;
an upper rod pivotally coupled to the second portion of the handle and translationally coupled to the upper guide via two regions of engagement;
a lower rod pivotally coupled to the second portion of the handle and translationally coupled to the lower guide via two regions of engagement;
wherein rotation of the handle causes translational movement of the upper rod relative to the upper guide in a line of motion defined by the two regions of engagement at the upper guide;
wherein rotation of the handle causes translational movement of the lower rod relative to the lower guide in a line of motion defined by the two regions of engagement at the lower guide; and
wherein each of the upper and lower guides comprises two regions of engagement configured to permit translational motion of the respective upper and lower rods in a line of motion defined by the respective two regions of engagement and configured to restrain non-translational motion thereof, thereby permitting substantially only translational motion of the upper and lower rods in a line of motion defined by the respective two regions of engagement.

2. The locking mechanism of claim 1, wherein the upper guide and the lower guide are C-shaped and are identically configured with respect to each other.

3. The locking mechanism of claim 1, wherein:
the two regions of engagement of the upper guide are defined by two holes, an upper hole and a lower hole, the upper and lower holes of the upper guide being configured to provide for a rattle-free condition of the cabinet door when in a closed and locked position while not overly binding the upper rod from extending into the locked position; and
the two regions of engagement of the lower guide are defined by two holes, an upper hole and a lower hole, the upper and lower holes of the lower guide being configured to provide for a rattle-free condition of the cabinet door when in a closed and locked position while not overly binding the lower rod from extending into the locked position.

4. The locking mechanism of claim 3, wherein:
the two holes of the upper guide are equally sized; and
the two holes of the lower guide are equally sized.

5. The locking mechanism of claim 3, wherein:
the upper hole of the upper guide is smaller than the lower hole of upper guide; and
the lower hole of the lower guide is smaller than the upper hole of the lower guide.

6. The locking mechanism of claim 3, wherein:
the upper hole of the upper guide is circular and the lower hole of the upper guide is oblong; and
the lower hole of the lower guide is circular and the upper hole of the lower guide is oblong.

7. The locking mechanism of claim 4, further comprising:
an insert having a through hole and being disposed in the upper hole of the upper guide;
wherein the upper rod passes through the lower hole of the upper guide and the through hole of the insert, the upper rod having more clearance to an inner edge of the lower hole than to an inner edge of the insert.

8. The locking mechanism of claim 7, further comprising:
a second insert having a through hole and being disposed in the lower hole of the lower guide;
wherein the lower rod passes through the upper hole of the lower guide and the through hole of the second insert, the lower rod having more clearance to an inner edge of the upper hole than to an inner edge of the second insert.

9. The locking mechanism of claim 7, wherein the insert is made of a material comprising plastic.

10. The locking mechanism of claim 1, wherein the upper guide and the lower guide are disposed no closer than 18 inches with respect to the pivot of the handle.

11. The locking mechanism of claim 1, wherein the handle is positionable in a first position and a second position;
the first position resulting in:
the upper rod having its upper end partially restrained by the two regions of engagement in the upper guide and being positioned in a retracted position; and
the lower rod having its lower end partially restrained by the two regions of engagement in the lower guide and being positioned in a retracted position; and
the second position resulting in:
the upper rod having its upper end partially restrained by the two regions of engagement in the upper guide and being positioned in an extended position; and
the lower rod having its lower end partially restrained by the two regions of engagement in the lower guide and being positioned in an extended position.

12. The locking mechanism of claim 11, wherein the second portion of the handle comprises a mounting portion and a latch portion, the upper rod and the lower rod each being pivotally coupled to the mounting portion;
wherein the first position of the handle results in the latch portion being shadowed by the door when viewed from the front side of the door; and
wherein the second position of the handle results in the latch portion extending beyond an outer edge of the door when viewed from the front side of the door.

13. The locking mechanism of claim 7, wherein:
the insert is securely connected to the upper hole of the upper guide via a snap-fit engagement

14. The locking mechanism of claim 1, wherein:
at least one of the upper guide and the lower guide has a length equal to or greater than 5 inches and equal to or less than 7 inches.

15. A cabinet, comprising:
a body;
a door hinged to the body and capable of being opened and closed, the body and door defining an interior space of the cabinet; and
a locking mechanism comprising:
a handle pivotally attached to the door, the handle having a first portion on a front side of the door and a second portion on a back side of the door, the first portion being rigidly connected with the second portion such that rotation of the first portion causes rotation of the second portion;
an upper guide and a lower guide each fixedly attached to the back side of the door such that the upper and lower guides and the handle pivot are disposed substantially inline with each other proximate an edge of the door opposite the hinged edge of the door;
an upper rod pivotally coupled to the second portion of the handle and translationally coupled to the upper guide via two regions of engagement;
a lower rod pivotally coupled to the second portion of the handle and translationally coupled to the lower guide via two regions of engagement;
wherein rotation of the handle causes translational movement of the upper rod relative to the upper guide in a line of motion defined by the two regions of engagement at the upper guide;
wherein rotation of the handle causes translational movement of the lower rod relative to the lower guide in a line of motion defined by the two regions of engagement at the lower guide; and
wherein each of the upper and lower guides comprises two regions of engagement configured to permit translational motion of the respective upper and lower rods in a line of motion defined by the respective two regions of engagement and configured to restrain non-translational motion thereof, thereby permitting substantially only translational motion of the upper and lower rods in a line of motion defined by the respective two regions of engagement.

16. The cabinet of claim 15, wherein the handle is positionable in a first position and a second position;
the first position resulting in:
the upper rod having its upper end partially restrained by the two regions of engagement in the upper guide and being positioned in a retracted position; and
the lower rod having its lower end partially restrained by the two regions of engagement in the lower guide and being positioned in a retracted position; and
the second position resulting in:
the upper rod having its upper end partially restrained by the two regions of engagement in the upper guide and being positioned in an extended position; and
the lower rod having its lower end partially restrained by the two regions of engagement in the lower guide and being positioned in an extended position;
wherein the first position allows the door to be opened and closed, and the second position allows the door to be closed and locked with a two-point locking arrangements; and further wherein:
the two regions of engagement of the upper guide are defined by two holes, an upper hole and a lower hole, the upper and lower holes of the upper guide being configured to provide for a rattle-free condition of the cabinet door when in a closed and locked position while not overly binding the upper rod from extending into the locked position; and
the two regions of engagement of the lower guide are defined by two holes, an upper hole and a lower hole, the upper and lower holes of the lower guide being configured to provide for a rattle-free condition of the cabinet door when in a closed and locked position while not overly binding the lower rod from extending into the locked position.

17. The cabinet of claim 16, wherein the second portion of the handle comprises a mounting portion and a latch portion, the upper rod and the lower rod each being pivotally coupled to the mounting portion;
wherein the first position of the handle results in the latch portion being shadowed by the door when viewed from the front side of the door;
wherein the second position of the handle results in the latch portion extending beyond an outer edge of the door when viewed from the front side of the door; and
wherein the second position allows the door to be closed and locked with a three-point locking arrangement.

18. (canceled)

19. The locking mechanism of claim 2, wherein:
each of the upper and lower C-shaped guides comprise a dimension “L” between the respective two regions of engagement;
each of the upper and lower C-shaped guides are disposed a minimum dimension “d” from the handle pivot; and
the minimum dimension “d” is in accordance with a ratio d/L=6.

20. The locking mechanism of claim 1, wherein each of the upper and lower guides have their respective two regions of engagement disposed inboard of the respective upper and lower edges of the door.

21. A locking mechanism for a cabinet door, the locking mechanism comprising:
a handle pivotally attached to the cabinet door, the handle having a first portion on a front side of the door and a second portion on a back side of the door, the first portion being rigidly connected with the second portion such that rotation of the first portion causes rotation of the second portion;
an upper guide and a lower guide each fixedly attached to the back side of the door such that the upper and lower guides and the handle pivot are disposed substantially inline with each other proximate an edge of the door opposite a hinged edge of the door;
an upper rod pivotally coupled to the second portion of the handle and translationally coupled to the upper guide via two regions of engagement;
a lower rod pivotally coupled to the second portion of the handle and translationally coupled to the lower guide via two regions of engagement;
wherein rotation of the handle causes translational movement of the upper rod relative to the upper guide in a line of motion defined by the two regions of engagement at the upper guide;
wherein rotation of the handle causes translational movement of the lower rod relative to the lower guide in a line of motion defined by the two regions of engagement at the lower guide; and
wherein the upper guide and the lower guide are disposed no closer than 18 inches with respect to the pivot of the handle.
